(19) United States
(12) Patent Application Publication
(10) Pub. No.: US 2013/0196277 A1
(43) Pub. Date: Aug. 1, 2013

(54) Regenerative Air Heater And Method of Operation

(71) Applicants: John N. Newby, Newburgh Hts., OH (US); Todd A. Miller, Garfield Hts., OH (US); Thomas F. Robertson, Medins Township, OH (US); Bruce E. Cain, Akron, OH (US)

(72) Inventors: John N. Newby, Newburgh Hts., OH (US); Todd A. Miller, Garfield Hts., OH (US); Thomas F. Robertson, Medins Township, OH (US); Bruce E. Cain, Akron, OH (US)

(21) Appl. No.: 13/568,194

(22) Filed: Aug. 7, 2012

Related U.S. Application Data
(60) Provisional application No. 61/521,534, filed on Aug. 9, 2011.

(51) Int. Cl. F23L 15/02; F27D 17/00; C21B 9/14

(52) U.S. Cl. CPC F23L 15/02; C21B 9/14; F27D 17/00
USPC 432/30; 432/182; 432/40; 432/217

(57) ABSTRACT

A flow of air is provided from a hot air main into a combustion chamber at a time when a burner is firing into the combustion chamber to heat a bed of regenerative media. The flow of air into the combustion chamber helps to keep products of combustion from flowing into the hot air main. In preferred embodiments, sensors sense pressure in the combustion chamber and the hot air main. A controller shifts a valve back and forth within a range of open conditions to regulate the flow of air in response to the sensed pressures.

### RELATED APPLICATIONS

This application claims the piority benefit of provisional U.S. patent application 61/521,534, filed Aug. 9, 2011, which is incorporated by reference.

### TECHNICAL FIELD

This technology includes air heaters that operate in alternating regenerative modes.

### BACKGROUND

Certain industrial processes, including heating, drying, calcining, melting, and chemical processing applications, may require a stream of clean process air at an elevated temperature. A regenerative air heater can be used to provide the stream of clean, hot process air. Such an air heater operates in alternating regenerative modes. In a charge mode, burners fire into combustion chambers. This provides products of combustion for heating beds of regenerative media that are located in or adjacent to the combustion chambers. In a discharge mode, unheated atmospheric air is heated to an elevated temperature by forcing it to flow into the combustion chambers through the heated beds of regenerative media. The hot air flows from the combustion chambers into a hot air main that directs it to an industrial processing location.

When a burner is firing into a combustion chamber in a charge mode, the combustion chamber is isolated from the hot air main by a hot blast valve that blocks products of combustion from flowing into the hot air main. When the air heater is shifted to the discharge mode, the hot blast valve is opened to allow the heated air to flow outward from the combustion chamber and into the hot air main.

### SUMMARY OF THE INVENTION

An apparatus comprises means for providing a flow of air from a hot air main into a combustion chamber at a time when a burner is firing into the combustion chamber to heat a bed of regenerative media. The flow of air into the combustion chamber helps to keep products of combustion from flowing into the hot air main.

In preferred embodiments, sensors sense pressure in the combustion chamber and the hot air main. A controller shifts a valve back and forth within a range of open conditions to regulate the flow of air in response to the sensed pressures.

The invention also provides methods of providing open gas pressure and flow communication between a hot air main and a combustion chamber when a burner is firing into the combustion chamber to heat a bed of regenerative media. The methods preferably monitor and regulate a flow of air from the hot air main into the combustion chamber by monitoring and regulating a pressure drop from the hot air main to the combustion chamber.

### BRIEF DESCRIPTION OF THE DRAWINGS

FIG. 1 is a schematic view of parts of a regenerative air heater.

FIG. 2 is a sectional view taken on line 2-2 of FIG. 1.

FIG. 3 is a sectional view taken on line 3-3 of FIG. 1.

FIG. 4 is a block diagram of control system components operatively associated with the air heater of FIG. 1.

FIG. 5 is a view similar to FIG. 1, showing the air heater in an alternative operating condition.

FIG. 6 is an enlarged partial view of the air heater of FIG. 1.

FIG. 7 is a view similar to FIG. 6, showing parts of an alternate embodiment of a regenerative air heater.

FIG. 8 is a view similar to FIG. 1, showing parts of another alternate embodiment of a regenerative air heater.

FIG. 9 is an enlarged partial view of the air heater of FIG. 8.

FIG. 10 is a block diagram of control system components operatively associated with the air heater of FIG. 8.

### DETAILED DESCRIPTION

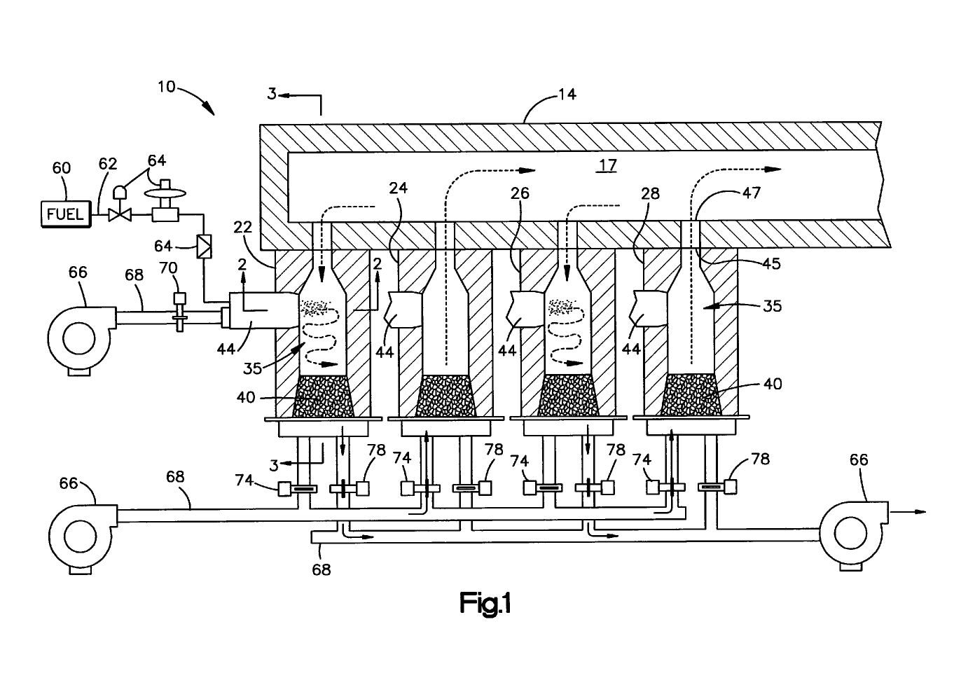

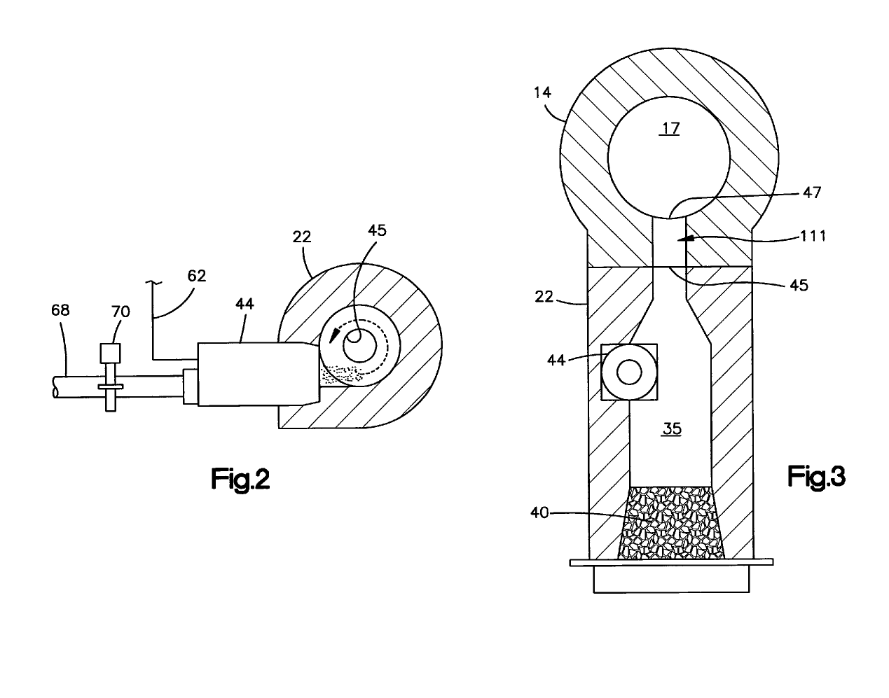

The apparatus 10 shown in FIG. 1 is a regenerative air heater. The various parts of the air heater 10, as shown, described and claimed, may be of original and/or retrofitted construction as required to accomplish any particular implementation of the invention.

In this embodiment, the air heater 10 includes a header 14 defining a hot air main 17. The header 14 is located above a group of regenerative combustion chamber modules, four of which 22, 24, 26 and 28 are shown in FIG. 1. The air heater 10 operates to heat ambient atmospheric air to an elevated temperature, such as 2,000 degrees F. or more, by driving it upward through the modules 22-28. The hot air then flows from the modules 22-28 into the hot air main 17, which directs it to flow as a stream or blast to a processing location such as a blast furnace or other heating, drying or melting apparatus.

Each of the modules 22-28, which may be referred to as stoves, defines a combustion chamber 35. Each of the modules 22-28 also contains a bed of regenerative media 40, and has a burner 44 configured to fire into the respective combustion chamber 35 to heat the bed of regenerative media 40. Outlets 45 at the upper ends of the modules 22-28 are aligned with inlets 47 in the header 14 to communicate the combustion chambers 35 with the hot air main 17. The outlets 45 from the combustion chambers 35 may be referred to as hot blast outlets.

The burners 44 receive fuel gas from a source 60 through fuel lines 62 with fuel valves 64. The burners 44 also receive combustion air from a blower system 66 through a duct system 68 with combustion air valves 70. Unheated atmospheric air can be driven into the modules 22-28 through cold air inlet valves 74. Exhaust gases can be drawn outward from the modules 22-28 through exhaust valves 78.

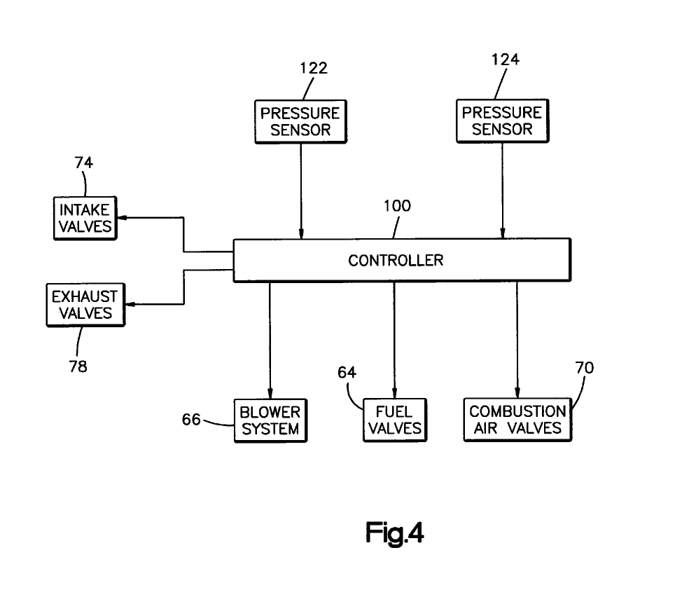

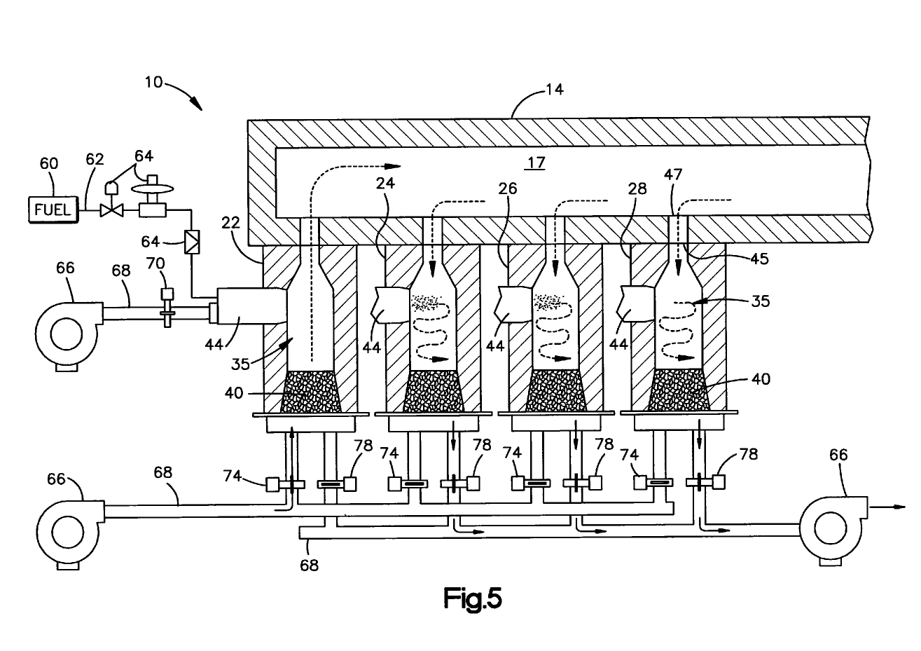

As shown schematically in FIG. 4, a controller 100 is operatively associated with the blower system 66 and the valves 64, 70, 74 and 78. The controller 100, which may comprise any suitable programmable logic controller or other device, or combination of such devices, has hardware and/or software configured to operate the blower system 66 and the valves 64, 70, 74 and 78 as described and claimed.

Each of the modules 22-28 can be operated in differing modes. These include a charge mode, as illustrated in FIG. 1 at the first and third modules 22 and 26. In the charge mode, a burner 44 receives firing levels of fuel and combustion air for firing into the respective combustion chamber 35. The inlet valve 74 at that module is closed, and the exhaust valve 78 is open. The products of combustion in the chamber 35 are drawn downward through the bed of regenerative media 40 to heat the regenerative media 40, and are further drawn outward through the open exhaust valve 78.

An alternative to the charge mode is a discharge mode. This is illustrated in FIG. 1 at the second and fourth modules 24 and 28. In the discharge mode, the burner 44 does not receive firing levels of fuel and combustion air. The inlet valve 74 is open, and the exhaust valve 78 is closed. Ambient atmospheric air is driven upward through the open inlet valve 74 and through the bed of regenerative media 40, which was heated in a previous firing cycle of the burner 44 in the charge mode. This heats the air, which is driven further upward from the combustion chamber 35 through the module outlet 45, into the header 14 through the adjacent inlet 47, and onward through the hot air main 17 to the processing location.

The discharge mode follows the charge mode, but a brief purge mode is preferably interposed between the charge mode and the discharge mode. In the purge mode, the inlet valve 74 at the module remains closed and the exhaust valve 78 remains open, as in the charge mode. However, the burner 44 is not fired into the combustion chamber 35. While the exhaust valve 78 remains open in the purge mode, residual products of combustion generated in the previous charge mode can exit the module through the open exhaust valve 78. The outward flow of combustion products may be driven in part by a continued flow of air into the combustion chamber 35 through the burner 44. This purges the module of residual combustion products that could otherwise be carried upward from the combustion chamber 35 to the hot air main 17 in the next following discharge mode.

The controller 100 is configured to operate each of the modules 22-28 independently of the others, and to cycle each module between the various modes. Preferably, the mode cycles are timed to provide the main 17 with a flow of hot air that is continuous and substantially free of combustion products. This can be accomplished by timing the mode cycles so that at least one module is operating in the discharge mode while the others are operating in the charge or purge modes. For example, as shown in FIG. 5, the first module 22 is operated in the discharge mode while the second and third modules 24 and 26 are in the charge mode and the fourth module 28 is in the purge mode.

A module may also have a pause mode in which the inlet and exhaust valves 74 and 78 are both closed, and the burner 44 is off. Cycling a module into and out of such a pause mode enables heat to be stored and released as needed for changes in load demand.

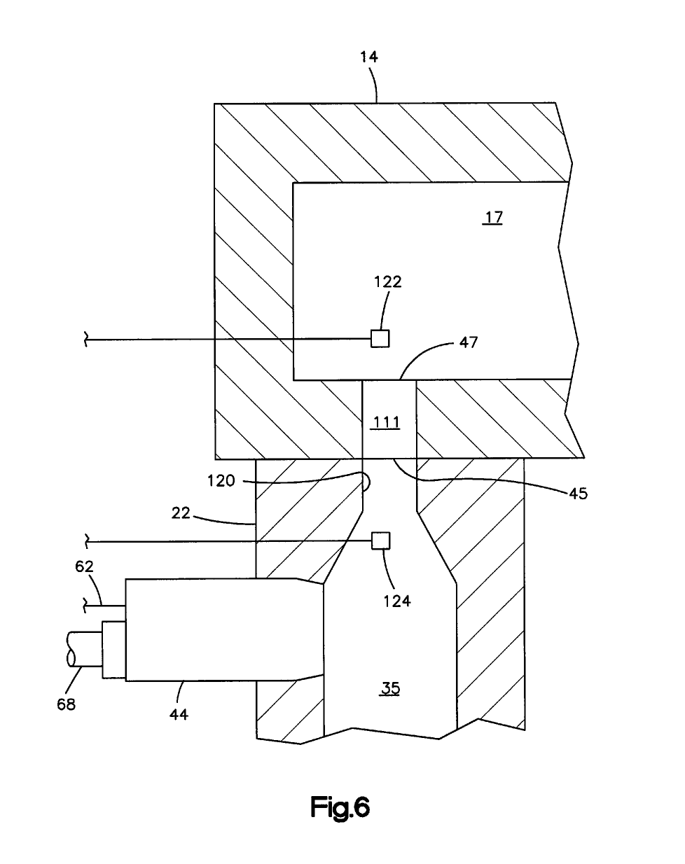

In each of the modes of operation shown in FIGS. 1 and 5, the air heater 10 has open air flow communication through air flow passages 111 between the combustion chambers 35 and the hot air main 17. The air flow passages 111 are preferable alike, with each having the configuration shown for example in FIG. 6 with reference to the module 22. Each air flow passage 111 thus extends through a throat structure 120 which is defined in part by the header 14 and in part by the respective module. Each throat structure 120 reaches fully from the adjacent combustion chamber 35 to the inlet at the hot air main 17, and is free of a valve for closing or regulating the flow area through the passage 111. Accordingly, the passages 111 in this embodiment provide fully and permanently open pressure and flow communication between the air in the hot air main 17 and the gaseous combustion products and/or air in the combustion chambers 35.

Also shown in FIG. 6 is a sensor 122 for sensing the pressure in the hot air main 17 adjacent to the air flow passage 111. Another sensor 124 senses the pressure in the combustion chamber 35 adjacent to the air flow passage 111. Similar sensors 122 and 124 are provided for the other passages 111, but are omitted from the drawings for clarity of illustration.

Each throat 120 structure provides a restriction in flow area through the passage 111 between the combustion chamber 35 and the hot air main 17. The restriction may be incorporated in the outlet 45 of the combustion chamber 35, in the inlet 47 of the hot air main 17, or in both as shown in FIG. 6. The restriction in flow area is sufficient to create a measurable difference between the pressures sensed by the pressure sensors 122 and 124 in the main 17 and the combustion chamber 35 when there is flow either from the main 17 into the combustion chamber 35, or from the combustion chamber 35 into the main 17.

In addition to cycling the modules 22-28 between the differing modes described above, the controller 100 (FIG. 4) is configured to operate in response to the pressure sensors 122 and 124. This enables the controller 100 to provide and maintain flows of air from the hot air main 17 into the modules that are operating in the charge or purge modes. The flows of air into the combustion chambers 35 help to keep products of combustion out of the heated process air that is conveyed through the hot air main 17 to the industrial processing location.

Specifically, when a combustion chamber 35 contains primary products of combustion in the charge mode, or residual products of combustion in the purge mode, the blower system 66 and the valves 64, 70, 74 and 78 normally provide greater pressure in the hot air main 17 than in the combustion chamber 35. This pressure differential normally drives a flow of air from the hot air main 17 into the combustion chamber 35 through the passage 111. The controller 100 monitors the flow of air by monitoring the pressure differential between the two sensors 122 and 124 adjacent to the passage 111. The controller 100 also regulates the flow of air by shifting the exhaust valve 78 back and forth within a range of open conditions in response to changes in the pressure differential.

For example, if the controller 100 detects a decrease in the amount by which the sensed pressure in the hot air main 17 exceeds the sensed pressure in the combustion chamber 35, it can compare the decreased pressure drop with a range of values that are predetermined to provide desired air flow rates inward through the passage 111. If the decreased pressure drop is below the predetermined range, the controller 100 can respond by shifting the exhaust valve 78 from an open condition to a more fully open condition. The increased flow area through the exhaust valve 78 enables an increased flow rate of exhaust gas outward from the combustion chamber 35 which, in turn, enables an increased flow rate of air inward through the passage 111. Likewise, if the controller 100 detects an increase in the pressure drop from the hot air main 17 to the combustion chamber 35, it can decrease the flow rate of air inward through the passage 111 by shifting the exhaust valve 78 to a less fully open condition. In either case, the controller 100 preferably seeks to maintain the pressure drop within a predetermined range to provide a predetermined range of air flow rates into a combustion chamber 35 operating in the charge or purge mode.

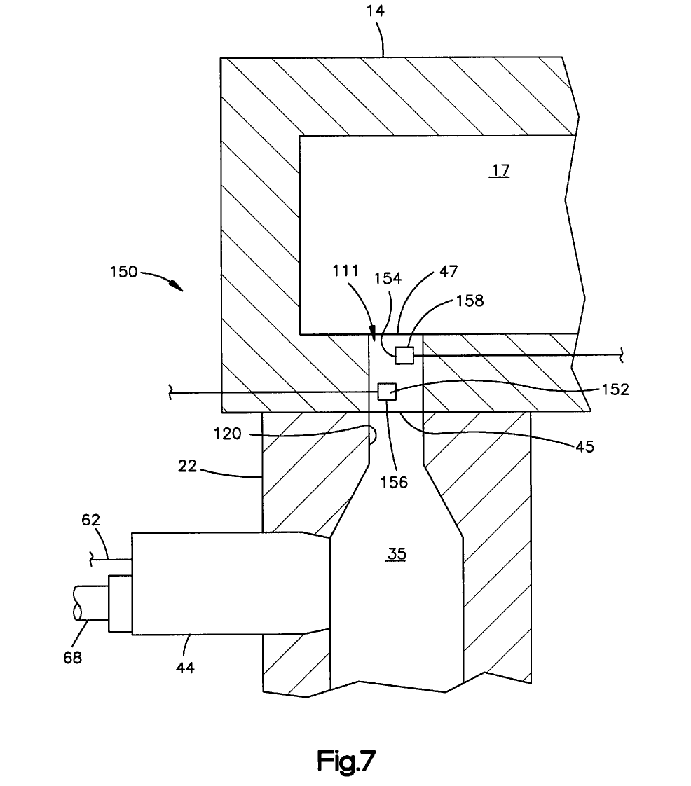

In the embodiment described above, the pressure sensors 122 and 124 are static pressure sensors. An alternative embodiment may include velocity pressure sensors in place of, or along with, static pressure sensors. For example, as shown in FIG. 7, a regenerative air heater 150 has parts that are the same or substantially the same as corresponding parts of the air heater 10, and such parts are indicated by the same reference numbers. This air heater 150 further has a pair of velocity pressure sensors 152 and 154 in each of the air flow passages 111 between the combustion chambers 35 and the hot air main 17. The first velocity pressure sensor 152 in each pair has a sensing port 156 facing directly downward toward the adjacent combustion chamber 35. The second velocity pressure sensor 154 in each pair has a sensing port 158 facing directly upward toward the hot air main 17. The two velocity pressure sensors 152 and 154 are thus oriented to operate as total pressure sensors regarding flows of gas upward and downward, respectively, through the passage 111.

The sensed pressures of gas flowing through the passages 111 can serve as indicators of the pressures in the combustion chambers 35 and the main 17, and can thus serve as indicators of pressure differentials and flows of gas between the combustion chambers 35 and the main 17.

Accordingly, with a first velocity pressure sensor 152 oriented to provide an increasing pressure signal in response to increasing velocity of gas flowing from a combustion chamber 35 to the main 17, and a second velocity pressure sensor 154 oriented to provide an increasing pressure signal in response to increasing velocity of gas flowing from the main 17 to the combustion chamber 35, a difference between the two signals can be used by the controller 100 in the same way as described above for the pressure sensors 122 and 124.

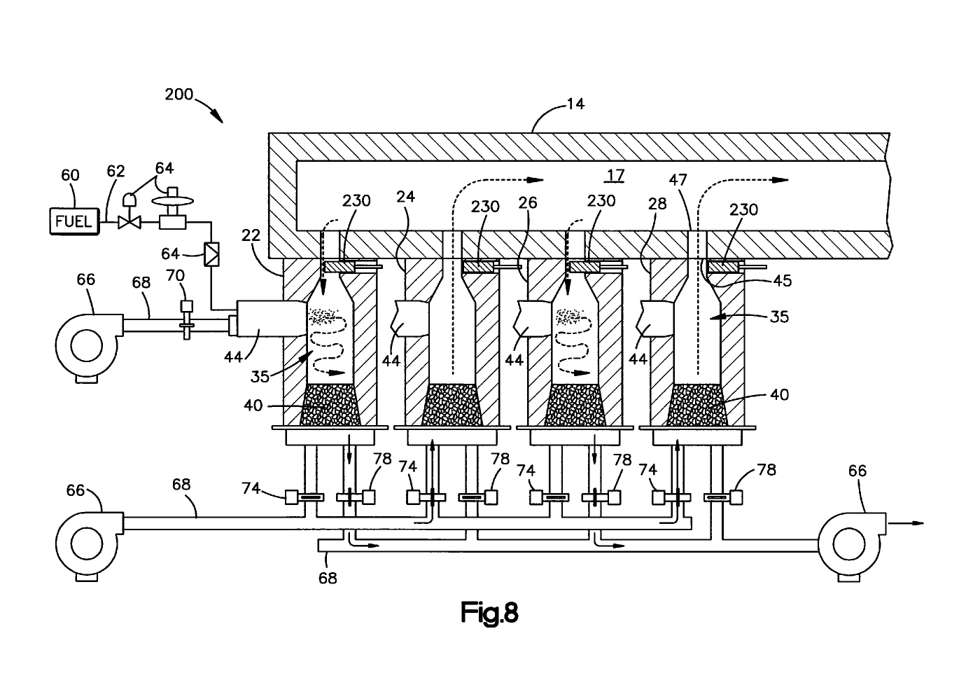

Another alternative embodiment of a regenerative air heater 200 is shown schematically in FIGS. 8-10. This air heater 200 also has many parts that are the same or substantially the same as corresponding parts of the air heater 10, as indicated by the same reference numbers in the drawings. However, the air heater 200 has throat structures 220 and a controller 222 that differ from the throat structures 120 and the controller 100 in the air heater 10.

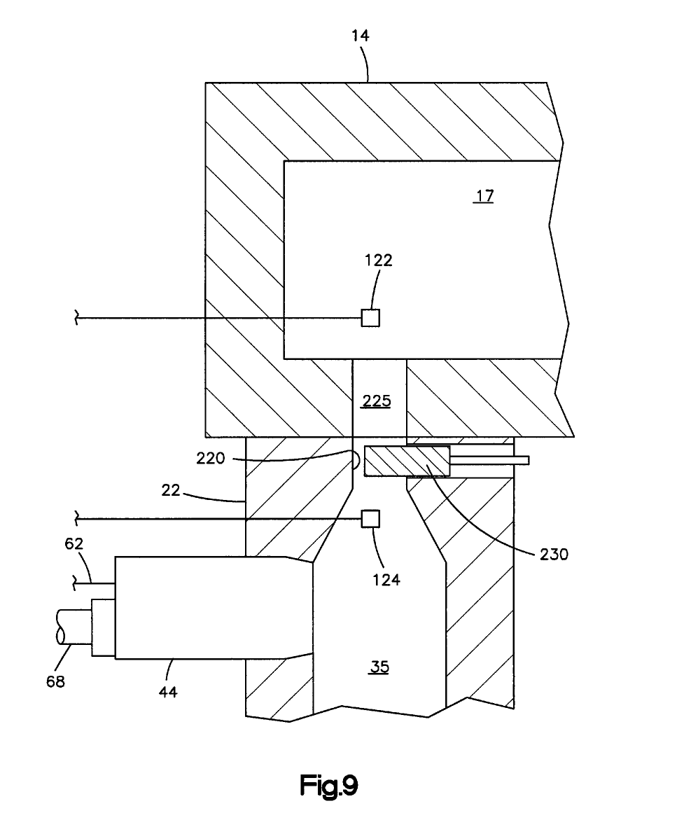

Each throat structure 220 (FIG. 9) in the air heater 200 defines an air flow passage 225 that reaches fully between the hot air main 17 and the adjacent combustion chamber 35. Each throat structure 220 is thus configured to provide pressure and flow communication between air in the hot air main 17 and gaseous combustion products and/or air in the combustion chamber 35. However, unlike the throat structures 120 described above, each throat structure 220 includes an air valve 230 for regulating a flow area in the passage 225. The air valves 230 are preferably configured as slider valves, as shown in FIGS. 8 and 9.

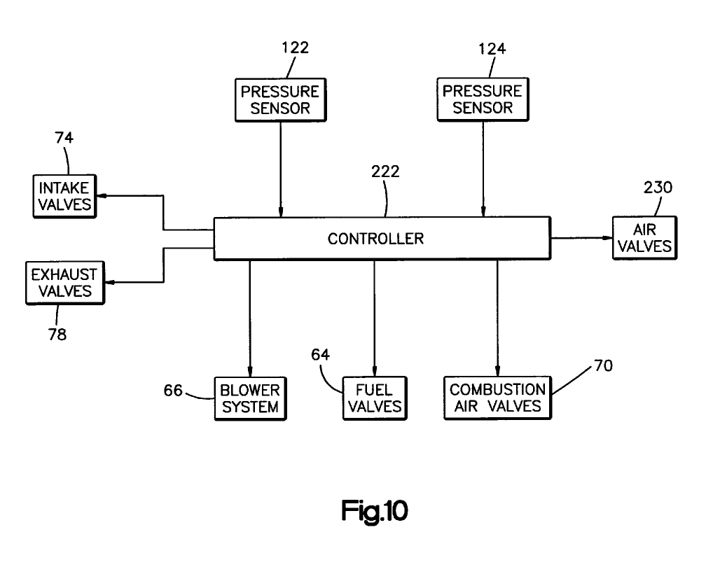

The controller 222 (FIG. 10) in the air heater 200 is configured to cycle between modes of operation as described above, and is preferably configured to operate the exhaust valves 78 in response to the pressure sensors 122 and 124 as described above. In this embodiment, the controller 222 is also configured to operate the air valves 230 in response to the pressure sensors 122 and 124.

When heated air is flowing upward to the hot air main 17 though a passage 225 in the discharge mode, the controller 222 can operate the air valve 230 at that passage 225 to regulate the upward flow of air, but preferably holds the air valve 230 in a fully open condition. When a burner 44 is firing into a combustion chamber 35 in the charge mode, or when the combustion chamber 35 is in the purge mode, the controller 222 can also operate the air valve 230 at the corresponding passage 225 as needed to regulate a downward flow of air from the hot air main 17 into the combustion chamber 35. As described above with reference to the exhaust valves 78, this is accomplished by shifting the air valve 230 back and forth within a range of open conditions in response to changes in a pressure differential indicated by the sensors 122 and 124.

Accordingly, when a module is in the charge mode or the purge mode, the controller 222 may detect a decrease in the amount by which the sensed pressure in the hot air main 17 exceeds the sensed pressure in the combustion chamber 35. The controller 222 can then respond to the sensors 122 and 124 by shifting the corresponding air valve 230 from an open condition to a more fully open condition to increase the flow rate of air inward through the passage 225. If the sensors 122 and 124 indicate an increase in the pressure drop from the hot air main 17 to the combustion chamber 35, the controller 222 can decrease the flow rate of air inward through the passage 225 by shifting the air valve 230 to a less fully open condition. In each case, the controller 222 can operate an air valve 230 along with the corresponding exhaust valve 78, or instead of the corresponding exhaust valve 78, to maintain desired air flow rates in this manner.

An air valve 230 can also be shifted to a closed condition if necessary to block products of combustion from escaping a combustion chamber 35 through the passage 225 to the hot air main 17. An air valve 230 may thus perform the function of a conventional hot blast valve. However, each air valve 230 is normally open in the charge and purge modes of operation, and the controller 222 preferably operates each air valve 230 to maintain a pressure drop within a predetermined range to provide a predetermined range of air flow rates into the combustion chamber 35 continuously throughout the charge and purge modes.

This written description sets for the best mode of the invention, and describes the invention so as to enable a person of ordinary skill in the art to make and use the invention, by presenting embodiments that include examples of the elements recited in the claims. All or part of each embodiment can be used in combination with all or part of any one or more of the others. The patentable scope of the invention is defined by the claims, and may include other examples that occur to those of ordinary skill in the art. Such other examples are intended to be within the scope of the claims if they do not differ from the literal language of the claims, or if they have insubstantial differences from the literal language of the claims.

1. An apparatus for use with a combustion chamber having an outlet to a hot air main, and a burner configured to fire into the combustion chamber to heat a bed of regenerative media, the apparatus comprising:
means for providing a flow of air from the hot air main into the combustion chamber through the outlet at a time when the burner is firing into the combustion chamber to heat the bed of regenerative media.

2. An apparatus as defined in claim 1 further comprising means for monitoring the flow of air, and means for responding to a decrease in the flow of air by increasing a flow of exhaust gas from the combustion chamber outward through the bed of regenerative media.

3. An apparatus for use with a combustion chamber having an outlet to a hot air main, and an exhaust valve that controls a flow of gas from the combustion chamber outward through a bed of regenerative media, the apparatus comprising:
a sensor that senses pressure in the combustion chamber;
a sensor that senses pressure in the hot air main; and
a controller configured to shift the exhaust valve back and forth within a range of open conditions in response to the sensed pressures.

4. An apparatus as defined in claim 3 wherein the controller is configured to monitor an amount by which the sensed pressure in the hot air main exceeds the sensed pressure in the combustion chamber, and to shift the exhaust valve from an open condition toward a more fully open condition in response to a decrease in the monitored amount.

5. An apparatus as defined in claim 3 further comprising an air valve that controls a flow of air through the outlet, and wherein the controller is further configured to shift the air valve within a range of open conditions in response to the sensed pressures.

6. An apparatus as defined in claim 5 wherein the air valve is shiftable into and out of a closed condition blocking air flow communication between the combustion chamber and the hot air main.

7. An apparatus for use with a combustion chamber, a hot air main, an air flow passage between the combustion chamber and the hot air main, and a burner configured to fire into the combustion chamber to heat a bed of regenerative media, the apparatus comprising:
an air valve that controls air flow communication through the air flow passage between the combustion chamber and the hot air main; and
a controller configured to shift the air valve back and forth within a range of open conditions at a time when the burner is firing into the combustion chamber to heat the bed of regenerative media.

8. An apparatus as defined in claim 7 wherein the air valve is shiftable into and out of a closed condition blocking air flow communication between the combustion chamber and the hot air main.

9. An apparatus as defined in claim 7 further comprising a sensor that senses pressure in the combustion chamber when the burner is firing into the combustion chamber to heat the bed of regenerative media, and a sensor that senses pressure in the hot air main when the burner is firing into the combustion chamber to heat the bed of regenerative media, with the controller being configured to shift the air valve back and forth within a range of open conditions in response to the sensed pressures when the burner is firing into the combustion chamber to heat the bed of regenerative media.

10. An apparatus as defined in claim 9 wherein the controller is configured to monitor an amount by which the sensed pressure in the hot air main exceeds the sensed pressure in the combustion chamber, and to shift the air valve from an open condition toward a more fully open condition in response to a decrease in the monitored amount.

11. An apparatus comprising:
a structure defining a combustion chamber;
a bed of regenerative media;
a burner that fires into the combustion chamber to heat the bed of regenerative media;
a hot air main; and
a throat structure defining an air flow passage that is open from the hot air main into the combustion chamber when the burner is firing into the combustion chamber.

12. An apparatus as defined in claim 11 wherein the throat structure includes an air valve that regulates air flow communication between the hot air main and the combustion chamber when the burner is firing into the combustion chamber to heat the regenerative media.

13. An apparatus as defined in claim 12 wherein the air valve is shiftable into and out of a closed condition blocking air flow communication between the combustion chamber and the hot air main.

14. A method of operating a regenerative heating apparatus having an outlet from a combustion chamber to a hot air main, and a burner that fires into the combustion chamber to heat a bed of regenerative media, the method comprising:
providing a flow of air from the hot air main to the combustion chamber through the outlet at a time when the burner is firing into the combustion chamber to heat the bed of regenerative media.

15. A method as defined in claim 14 wherein the providing step comprises monitoring the flow of air, and responding to a decrease in the flow of air by increasing a flow of exhaust gas from the combustion chamber outward through the bed of regenerative media.

16. A method of operating an apparatus having an outlet from a combustion chamber to a hot air main, and an exhaust valve that controls a flow of gas from the combustion chamber outward through a bed of regenerative media, the method comprising:
sensing pressure in the combustion chamber;
sensing pressure in the hot air main; and
shifting the exhaust valve back and forth within a range of open conditions in response to the sensed pressures.

17. A method as defined in claim 16 wherein further comprising monitoring an amount by which the sensed pressure in the hot air main exceeds the sensed pressure in the combustion chamber, and shifting the exhaust valve from an open condition toward a more fully open condition in response to a decrease in the monitored amount.

18. A method of operating an apparatus having an air valve that controls air flow communication between a combustion chamber and a hot air main, and a burner that fires into the combustion chamber to heat a bed of regenerative media, the method comprising:
shifting the air valve back and forth within a range of open conditions at time when the burner is firing into the combustion chamber to heat the bed of regenerative media.

19. A method as defined in claim 18 further comprising sensing pressure in the combustion chamber when the burner is firing into the combustion chamber to heat the bed of regenerative media, sensing pressure in the hot air main when the burner is firing into the combustion chamber to heat the bed of regenerative media, and shifting the air valve back and forth within a range of open conditions in response to the sensed pressures when the burner is firing into the combustion chamber to heat the bed of regenerative media.

20. A method as defined in claim 19 wherein further comprising monitoring an amount by which the sensed pressure in the hot air main exceeds the sensed pressure in the combustion chamber, and shifting the air valve from an open condition toward a more fully open condition in response to a decrease in the monitored amount.

21. A method of operating an apparatus having combustion chamber, a burner that fires into the combustion chamber to heat a bed of regenerative media, and a hot air main, the method comprising:
providing open gas pressure and flow communication between the hot air main and the combustion chamber at a time when the burner is firing into the combustion chamber.

22. A method as defined in claim 21 further comprising monitoring and regulating a pressure drop from the hot air main to the combustion chamber when the burner is firing into the combustion chamber, and thereby to monitor and regulate a flow of air from the hot air main into the combustion chamber when the burner is firing into the combustion chamber.
